(19) United States
(12) Patent Application Publication
(10) Pub. No.: US 2024/0314287 A1
(43) Pub. Date: Sep. 19, 2024

(54) METHOD AND APPARATUS FOR SUPPORTING 360 VIDEO

(71) Applicant: Samsung Electronics Co., Ltd., Gyeonggi-do (KR)

(72) Inventors: Eric YIP, Gyeonggi-do (KR); Sungryeul RHYU, Gyeonggi-do (KR); Hyunkoo YANG, Gyeonggi-do (KR); Jaeyeon SONG, Gyeonggi-do (KR)

(21) Appl. No.: 18/681,222

(22) PCT Filed: Aug. 3, 2022
(86) PCT No.: PCT/KR2022/011497

§ 371 Date: Feb. 5, 2024

(30) Foreign Application Priority Data
Aug. 3, 2021 (KR) 10-2021-0102120

(51) Int. Cl. H04N 13/282; H04N 13/366

(52) U.S. Cl. CPC H04N 13/282; H04N 13/366

(57) ABSTRACT

According to an embodiment of the disclosure, the method for supporting 360 video performed by a XR device includes obtaining a plurality of 360 video data, determining a 360 video to be displayed. based on a user pose information. determining a scene object. based on a media input and composing a 3D scene the 360 video and the scene object.

### TECHNICAL FIELD

The disclosure relates to multimedia content processing authoring, pre-processing, post-processing, metadata delivery, delivery, decoding and rendering of, virtual reality, mixed reality and augmented reality contents, including 2D video, 360 vidco, synthesized views, background viewport videos, 3D media represented by point clouds and meshes. Furthermore, the disclosure relates to scene descriptions, dynamic scene descriptions, dynamic scene descriptions supporting timed media, scene description formats, glTF. MPEG media, ISOBMFF file format. VR devices, XR devices. Support of immersive contents and media.

### BACKGROUND ART

Considering the development of wireless communication from generation to generation, the technologies have been developed mainly for services targeting humans, such as voice calls, multimedia services, and data services. Following the commercialization of 5G (5th-generation) communication systems, it is expected that the number of connected devices will exponentially grow. Increasingly, these will be connected to communication networks. Examples of connected things may include vehicles, robots, drones, home appliances, displays, smart sensors connected to various infrastructures, construction machines, and factory equipment. Mobile devices are expected to evolve in various form-factors, such as augmented reality glasses, virtual reality headsets, and hologram devices. In order to provide various services by connecting hundreds of billions of devices and things in the 6G (6th-generation) era, there have been ongoing efforts to develop improved 6G communication systems. For these reasons, 6G communication systems are referred to as beyond-5G systems.

6G communication systems, which are expected to be commercialized around 2030, will have a peak data rate of tera (1,000 giga)-level bps and a radio latency less than 100usec, and thus will be 50 times as fast as 5G communication systems and have the 1/10 radio latency thereof.

In order to accomplish such a high data rate and an ultra-low latency, it has been considered to implement 6G communication systems in a terahertz band (for example, 95 GHz to 3 THz bands). It is expected that, due to severer path loss and atmospheric absorption in the terahertz bands than those in mmWave bands introduced in 5G, technologies capable of securing the signal transmission distance (that is, coverage) will become more crucial. It is necessary to develop, as major technologies for securing the coverage, radio frequency (RF) elements, antennas, novel waveforms having a better coverage than orthogonal frequency division multiplexing (OFDM), beamforming and massive multiple input multiple output (MIMO), full dimensional MIMO (FD-MIMO), array antennas, and multiantenna transmission technologies such as large-scale antennas. In addition, there has been ongoing discussion on new technologies for improving the coverage of terahertz-band signals, such as metamaterial-based lenses and antennas, orbital angular momentum (OAM), and reconfigurable intelligent surface (RIS).

Moreover, in order to improve the spectral efficiency and the overall network performances, the following technologies have been developed for 6G communication systems: a full-duplex technology for enabling an uplink transmission and a downlink transmission to simultaneously use the same frequency resource at the same time; a network technology for utilizing satellites, high-altitude platform stations (HAPS), and the like in an integrated manner; an improved network structure for supporting mobile base stations and the like and enabling network operation optimization and automation and the like; a dynamic spectrum sharing technology via collison avoidance based on a prediction of spectrum usage; an use of artificial intelligence (AI) in wireless communication for improvement of overall network operation by utilizing AI from a designing phase for developing 6G and internalizing end-to-end AI support functions; and a next-generation distributed computing technology for overcoming the limit of UE computing ability through reachable super-high-performance communication and computing resources (such as mobile edge computing (MEC), clouds, and the like) over the network. In addition, through designing new protocols to be used in 6G communication systems, developing mecahnisms for implementing a hardware-based security environment and safe use of data, and developing technologies for maintaining privacy, attempts to strengthen the connectivity between devices, optimize the network, promote softwarization of network entities, and increase the openness of wireless communications are continuing.

It is expected that research and development of 6G communication systems in hyperconnectivity, including person to machine (P2M) as well as machine to machine (M2M), will allow the next hyper-connected experience. Particularly, it is expected that services such as truly immersive extended reality (XR), high-fidelity mobile hologram, and digital replica could be provided through 6G communication systems. In addition, services such as remote surgery for security and reliability enhancement, industrial automation, and emergency response will be provided through the 6G communication system such that the technologies could be applied in various fields such as industry, medical care, automobiles, and home appliances.

### DISCLOSURE OF INVENTION

### Technical Problem

Although scene descriptions (3D objects) and 360 videos are technologies which are well defined separately, technology solutions for use cases where both types of media are delivered and rendered together in the same space are sparse.

In order to support such use cases, 360 video must be defined within the same content space as the 3D objects in the scene, described by a scene description. In addition, the access, delivery and rendering of the different required components based on the user's pose information should be enabled such that various media functions can be present in alternative entities throughout the 5G system workflow, such as in the cloud (MEC (multi-access edge computing) or edge or MRF (media resource function)), or on the modem enabled UE device, or on a modem enabled device which is also connected to a tethered device.

In summary, this disclosure addresses:
Support of 360 video media as media components in a scene description
Support of 360 video media players as a plugin to a scene (description) renderer
Metadata to describe the 360 video space with respect to the scene (description) space
Metadata to describe the 360 video media components in the scene description
Metadata to enable view synthesis using 360 videos inside the scene
Embodiments for realizing the different end-to-end pipelines depending on the cloud and device configuration.

### Solution to Problem

According to an embodiment of the disclosure, the method for supporting 360 video performed by a XR device includes obtaining a plurality of 360 video data, determining a 360 video to be displayed, based on a user pose information, determining a scene object, based on a media input and composing a 3D scene the 360 video and the scene object.

### Advantageous Effects of Invention

The following is enabled by this invention:
Support of multiple 360 videos in a scene (description)
Support different rendering modes or scenarios for 360 videos in a scene, including the possibility to create synthesized views between 360 video data, through view synthesis.

### BRIEF DESCRIPTION OF DRAWINGS

FIG. 1 illustrates an example of a scene description (e.g. glTF) represented by a node trec.

FIG. 2 illustrates a spherical texture object, and two possible 360 texture videos.

FIG. 3 illustrates how multiple 360 videos can be used to create an interactive 360 experience.

FIG. 4 illustrates an architecture which can enable 360 view synthesis through the use of rectified ERP projection, and depth estimation.

FIG. 5 illustrates a graphical representation of the attributes defined in Table 2.

FIG. 6 illustrates the different rendering modes as defined by the renderMode attribute.

FIG. 7 illustrates an embodiment of present disclosure.

FIG. 8 illustrates an embodiment of present disclosure.

FIG. 9 illustrates an embodiment of present disclosure.

FIG. 10 illustrates placement of a view synthesizer component.

FIG. 11 illustrates a server according to embodiments of the present disclosure.

FIG. 12 illustrates a XR device according to embodiments of the present disclosure.

### BEST MODE FOR CARRYING OUT THE INVENTION

In order to support 360 video based experiences in a scene description, certain extensions to the MPEG scene description for a single 360 video texture is necessary. In addition, in order to support an interactive 360 video experience in a scene description, further extensions are necessary.

This disclosure includes embodiments to extend MPEG SD for single 360 video textures, and also to extend MPEG SD for an interactive 360 video experience, through interactive space descriptions which can also be used for space based rendering.

The different embodiments in this disclosure can be defined roughly into two cases:
Where a 360 video player (e.g. Omnidirectional Media Format (OMAF) player) is integrated into the scene description architecture as a plugin (whereby requiring metadata to define the matching of the rendering space and the reference point of the two coordinate systems)
Where 360 video content (e.g. OMAF content) is included and defined as textured objects in the scene description, and is decoded, processed and rendered as part of the scene description pipeline.

### Mode for the Invention

Throughout the disclosure, the expression “at least one of a, b or c” indicates only a, only b, only c, both a and b, both a and c, both b and c, all of a, b, and c, or variations thereof. Throughout the specification, a layer (or a layer apparatus) may also be referred to as an entity. Hereinafter, operation principles of the disclosure will be described in detail with reference to accompanying drawings. In the following descriptions, well-known functions or configurations are not described in detail because they would obscure the disclosure with unnecessary details. The terms used in the specification are defined in consideration of functions used in the disclosure, and can be changed according to the intent or commonly used methods of users or operators. Accordingly, definitions of the terms are understood based on the entire descriptions of the present specification.

For the same reasons, in the drawings, some elements may be exaggerated, omitted, or roughly illustrated. Also, a size of each element does not exactly correspond to an actual size of each element. In each drawing, elements that are the same or are in correspondence are rendered the same reference numeral.

Advantages and features of the disclosure and methods of accomplishing the same may be understood more readily by reference to the following detailed descriptions of embodiments and accompanying drawings of the disclosure. The disclosure may, however, be embodied in many different forms and should not be construed as being limited to the embodiments set forth herein; rather, these embodiments of the disclosure are provided so that this disclosure will be thorough and complete, and will fully convey the concept of the disclosure to one of ordinary skill in the art. Therefore, the scope of the disclosure is defined by the appended claims. Throughout the specification, like reference numerals refer to like elements. It will be understood that blocks in flowcharts or combinations of the flowcharts may be performed by computer program instructions. Because these computer program instructions may be loaded into a processor of a general-purpose computer, a special-purpose computer, or another programmable data processing apparatus, the instructions, which are performed by a processor of a computer or another programmable data processing apparatus, create units for performing functions described in the flowchart block(s).

The computer program instructions may be stored in a computer-usable or computer-readable memory capable of directing a computer or another programmable data processing apparatus to implement a function in a particular manner, and thus the instructions stored in the computer-usable or computer-readable memory may also be capable of producing manufactured items containing instruction units for performing the functions described in the flowchart block(s). The computer program instructions may also be loaded into a computer or another programmable data processing apparatus, and thus, instructions for operating the computer or the other programmable data processing apparatus by generating a computer-executed process when a series of operations are performed in the computer or the other programmable data processing apparatus may provide operations for performing the functions described in the flowchart block(s).

In addition, cach block may represent a portion of a module, segment, or code that includes one or more executable instructions for executing specified logical function(s). It is also noted that, in some alternative implementations, functions mentioned in blocks may occur out of order. For example, two consecutive blocks may also be executed simultaneously or in reverse order depending on functions corresponding thereto.

As used herein, the term “unit” denotes a software element or a hardware element such as a field-programmable gate array (FPGA) or an application-specific integrated circuit (ASIC), and performs a certain function. However, the term “unit” is not limited to software or hardware. The “unit” may be formed so as to be in an addressable storage medium, or may be formed so as to operate one or more processors. Thus, for example, the term “unit” may include elements (e.g., software elements, object-oriented software elements, class elements, and task elements), processes, functions, attributes, procedures, subroutines, segments of program code, drivers, firmware, micro-codes, circuits, data, a database, data structures, tables, arrays, or variables.

Functions provided by the elements and “units” may be combined into the smaller number of elements and “units”, or may be divided into additional elements and “units”. Furthermore, the elements and “units” may be embodied to reproduce one or more central processing units (CPUs) in a device or security multimedia card. Also, in an embodiment of the disclosure, the “unit” may include at least one processor. In the following descriptions of the disclosure, well-known functions or configurations are not described in detail because they would obscure the disclosure with unnecessary details.

Recent advances in multimedia include research and development into the capture of multimedia, the storage of such multimedia (formats), the compression of such multimedia (codecs etc), as well as the presentation of the such multimedia in the form of new devices which can provide users with more immersive multimedia experiences. With the pursuit of higher resolution for video, namely 8K resolution, and the display of such 8K video on ever larger TV displays with immersive technologies such as HDR, the focus in a lot of multimedia consumption has shifted to a more personalised experience using portable devices such as mobile smartphones and tablets. Another trending branch of immersive multimedia is virtual reality (VR), and augmented reality (AR). Such VR and AR multimedia typically requires the user to wear a corresponding VR or AR headset, or glasses (e.g. AR glasses), where the user's vision is surrounded by a virtual world (VR), or where the user's vision and surroundings is augmented by multimedia which may or may not be localised into his/her surroundings such that they appear to be a part of the real world surroundings.

360 video is typically viewed as 3DoF content, where the user only has a range of motion limited by the rotation of his/her head. With the advance of capturing technologies and the readily availability of both consumer and professional 360 cameras, many standard body requirements have begun to consider use cases where multiple 360 videos exist, each representing a different placement within a scene environment. Together with certain metadata which describes the relative location of these multiple 360 videos, an experience beyond 3DoF is made possible (e.g. an intermittent 6DoF experience). In order to create a smoother walk around like continuous 6DoF experience using 360 videos, some technologies can be used to create intermediate views between 360 video data, through view synthesis

A scene description is typically represented by a scene graph, in a format such as glTF or USD. A scene graph describes the objects in a scene, including their various properties, such as location, texture(s), and other information. A gITF scene graph expresses this information as a set of nodes which can be represented as a node graph. The exact format used for glTF is the JSON format, meaning that a glTF file is stored as a JSON document.

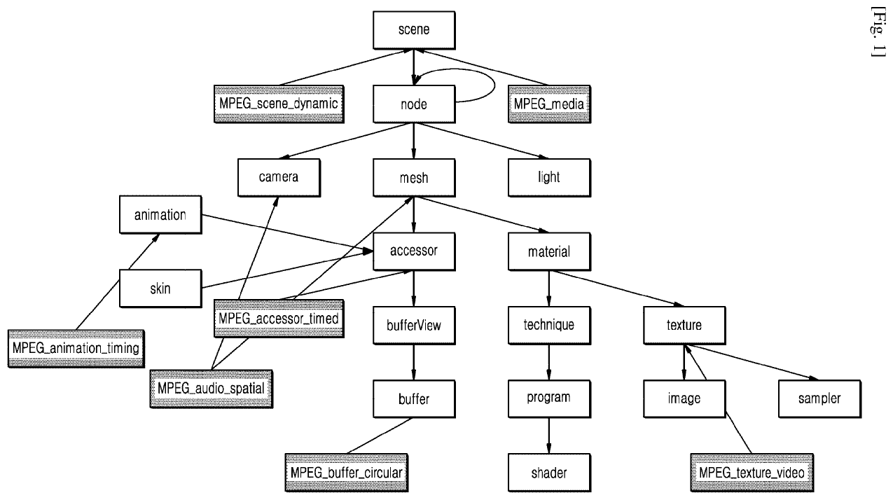

FIG. 1 illustrates an example of a scene description (c.g. glTF) represented by a node trec.

A scene description is the highest level files/format which describes the scene (e.g. a glTF file). The scene description typically describes the different media elements inside the scene, such as the objects inside the scene, their location in the scene, the spatial relationships between these objects, their animations, buffers for their data, etc.

Inside the scene description, there are typically 3D objects, represented by 3D media such as mesh objects, or point cloud objects. Such 3D media may be compressed using compression technologies such as MPEG V-PCC or G-PCC.

l White nodes represent those which are readily defined in scene graphs, whilst gray (shaded) nodes indicate the extensions which are defined in order to support timed (MPEG) media.

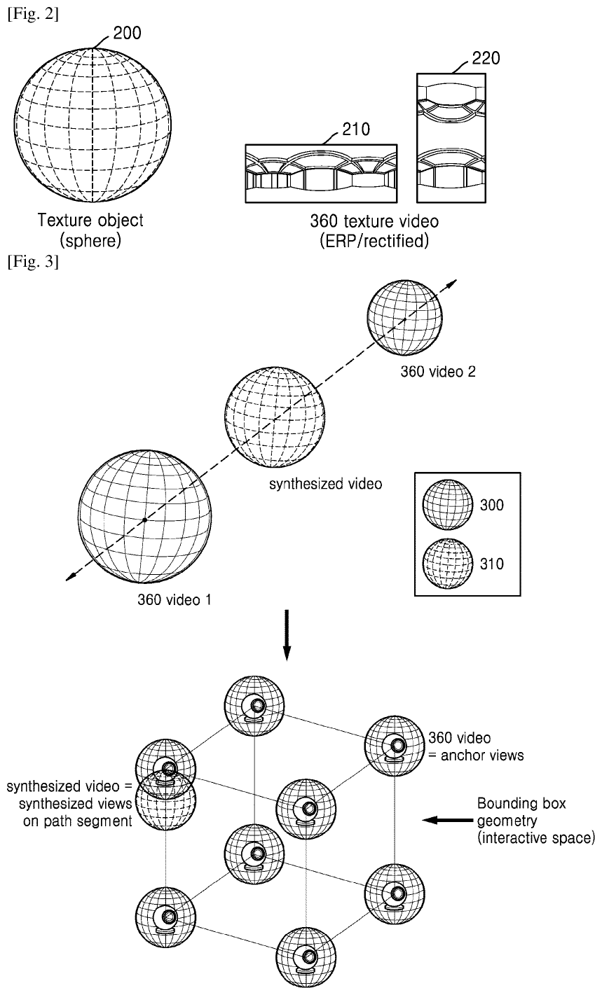

FIG. 2 illustrates a spherical texture object, and two possible 360 texture videos.

A texture object (200, a sphere in the case of ERP) is essentially a simple mesh object. Mesh objects are typically comprised of many triangular surfaces, on which the surfaces have certain textures (such as colour) overlaid to represent the mesh object.

360 texture video (210) is an equirectangular projected (ERP) 360 video. 360 texture video (220) rectified equirectangular projected (rectified ERP) 360 video. A 360 video is typically coded (stored and and compressed) as a projected form of traditional 2D video, using projections such as ERP and rectified ERP. This projected video texture is re-projected (or overlaid) back onto a texture object (200, a sphere in the case of ERP), which is then rendered to the user as a 360 video experience (where the user has 3 degrees of freedom). In other words, 360 texture videos (210, 220) are projected onto the surface of texture objects (200); the user's viewing location (his/her head) is typically located in the center of the texture object (200), such that he/she is surrounded by the surface of the texture object (200) in all directions. The user can see the 360 texture videos (210, 220) which have been projected onto the surface of the texture object (200). The user can move his/her head in a rotational manner (with 3 degrees of freedom), thus enabling a 360 video experience.

FIG. 3 illustrates how multiple 360 videos can be used to create an interactive 360 experience.

Sphere(s) 1 (300) represent 360 videos containing 360 video data which have been captured by real 360 degree Cameras, whilst sphere(s) 2 (310) represent synthesized 360 video which are synthesized using the data from the 360 video data around and adjacent to the synthesized sphere's location.

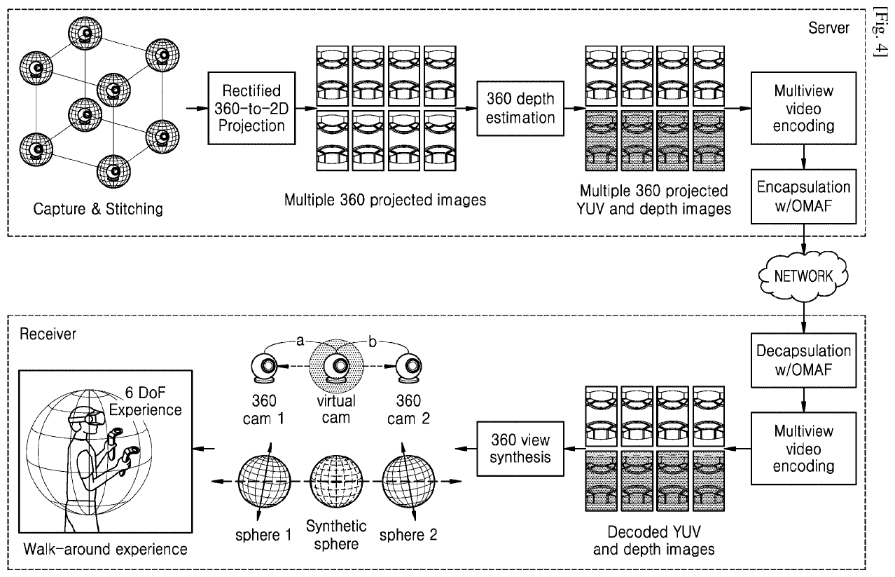

FIG. 4 illustrates an architecture which can enable 360 view synthesis through the use of rectified ERP projection, and depth estimation.

Multiple captured videos are stitched as multiple 360 videos, which are then projected as rectified ERP projected images/videos.

360 depth estimation is then carried out, after which both the video (YUV) data and the depth data are both encoded and encapsulated for storage and delivery.

On the receiver side, the YUV and depth data are decoded. YUV data corresponding to certain locations (sphere 1 and 2) are displayed to the user as simply rendered video, whilst locations without captured data are synthesized using the surrounding and/or adjacent YUV and depth data (as shown by Synthetic sphere).

TABLE 1

| | | | Sub- |
|---|---|---|---|
| Extension Name | Brief Description | Type | clause |
| MPEG_media | Extension for referencing | Generic | 5.2.1 |
| | external media sources. | | |
| MPEG_accessor_ | An accessor extension to | Generic | 5.2.2 |
| timed | support timed media. | | |
| MPEG_buffer_ | A buffer extension to support | Generic | 5.2.3 |
| circular | circular buffers. | | |
| MPEG_scene_ | An extension to support scene | Generic | 5.2.4 |
| dynamic | updates. | | |
| MPEG_texture_ | A texture extension to | Visual | 5.3.1 |
| video | support video textures. | | |
| MPEG_mesh_ | An extension to link two | Visual | 5.3.2 |
| linking | meshes and provide | | |
| | mapping information | | |
| MPEG_audio_spatial | Adds support for spatial audio. | Audio | 5.4.1 |
| MPEG_viewport_ | An extension to describe a | Metadata | 5.5.1 |
| recommended | recommended viewport. | | |
| MPEG_animation_ | An extension to control | Metadata | 5.5.2 |
| timing | animation timelines. | | |
| MPEG_360_video | An extension to support 360 | Visual | 5.x.x |
| | video projection textures. | | |
| MPEG_360_space | An extension to describe | Generic/ | 5.x.x |
| | a space containing | Metadata | |
| | 360 (OMAF) media. | | |

Table 1 shows a table containing different extensions defined by MPEG scene description (SD), shown by the text in black (corresponding to the grey (shaded) nodes in FIG. 1).

The present disclosure defines two new extensions (i.e. MPEG_360_video and MPEG_360_space), in order to support 360 video and interactive 360 video experiences in a scene.

TABLE 2

| Extension Name | Brief Description | Type | Subclause |
|---|---|---|---|
| MPEG_360_ | An extension to describe | Generic/ | 5.x.x |
| space | a space containing | Metadata | |
| | 360 (OMAF) media. | | |
| Name | Type | Default | Description |
| viewpoints | number | N/A | Number of OMAF viewpoints in the 360 space. |
| referencePoint | number | N/A | The coordinates of the reference point in the |
| | | | scene which corresponds to the origin defined |
| | | | by the OMAF coordinate system. The |
| | | | reference point is defined by x [symbol] y [symbol] z. |
| boundingVolume | number | BV_NONE | The type of the bounding volume for |
| | | | the OMAF space. Possible types are: |
| | | | BV_NONE: no bounding volume |
| | | | BV_CONE: capped cone bounding volume. |
| | | | defined by a circle at each anchor point. |
| | | | BV_CUBOID: a cuboid bounding volume. |
| | | | defined by size_x [symbol] size_y [symbol] size_z for each of |
| | | | the 2 faces containing the two anchor points. |
| | | | BV_SPHEROID: a spherical bounding |
| | | | volume around each point along the path |
| | | | segment. The bounding volume is defined |
| | | | by the radius of the sphere in each |
| | | | dimension [symbol] radius_x [symbol] radius_y [symbol] radius_z. |
| accessor | number | N/A | The index of the accessor or timed accessor |
| | | | that provides the OMAF space information. |

[symbol]

indicates data missing or illegible when filed

Table 2 defines the different attributes of the MPEG_360_space extension, which defines the physical 3D space in a scene inside which 360 videos are defined/available as media resources. The syntax of the attributes are shown under the “Name” column, and their corresponding semantics are shown under the “Description” column.

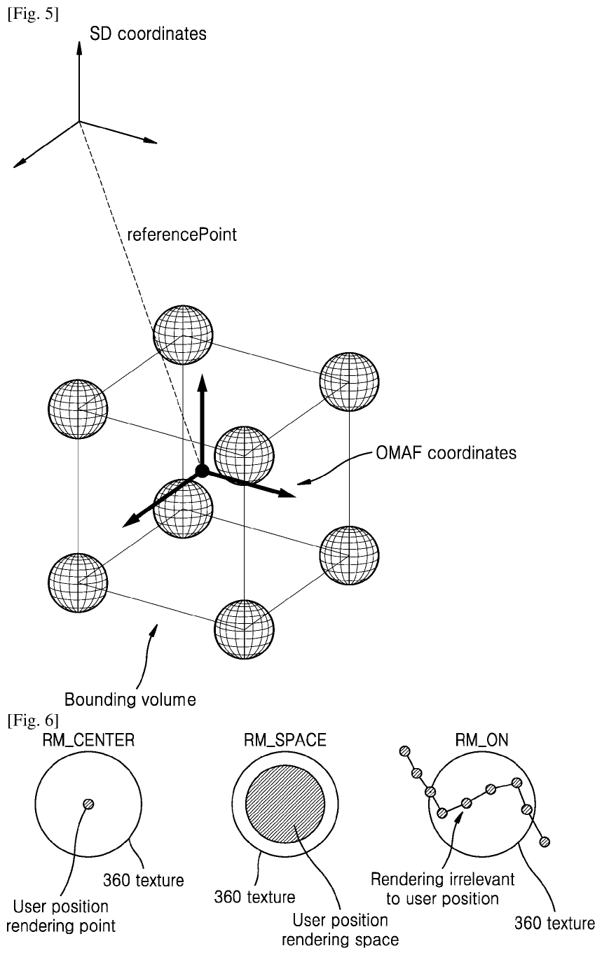

FIG. 5 illustrates a graphical representation of the attributes defined in Table 2. The placement of the 360 video volume space in the scene as defined by the extension MPEG_360_space, is defined by the referencePoint, which indicates the coordinates of the reference point in the scene (SD coordinates) which corresponds to the origin defined by the coordinate system used in OMAF 360 video media coordinates. The bounding volume can be defined using a number of different shape types, and multiple viewpoints each corresponding to either captured or synthesized 360 video can exist inside the bounding volume.

TABLE 3

| Extension | | | |
|---|---|---|---|
| Name | Brief Description | Type | Subclause |
| MPEG_360_ | An extension to | Visual | 5.x.x |
| video | support 360 video | | |
| | projection textures. | | |
| Name | Type | Default | Description |
| defaultFront | number | N/A | The default orientation of the texture object which |
| | | | corresponds to the default front orientation of the |
| | | | 360 video. |
| projectionType | number | PT_ | The type of the projection texture for the 360 video. |
| | | SPHERE | Possible types are: |
| | | | PT_ERP: a spherical projection texture object on |
| | | | which 360 ERP video is projected. The size of the |
| | | | sphere is defined by the radius of the sphere (in |
| | | | each dimension [symbol] radius_x [symbol] radius_y [symbol] radius_z). |
| | | | PT_CUBE: a cube bounding volume [symbol] defined by |
| | | | size_x [symbol] size_y [symbol] size_z for each axis of the cube. |
| TextureType | number | TT_ | The texture type of the 360 video. Possible types are: |
| | | YUV | TT_YUV: a projected video containing YUV data. |
| | | | TT_DEPTH: a projected video containing depth data. |
| renderMode | number | N/A | The rendering mode of the 360 video texture in the |
| | | | scene description. Possible modes are: |
| | | | RM_CENTER: texture is rendered only when the user |
| | | | is in the center coordinate of the texture (extend |
| | | | to a specific point in the texture?). |
| | | | RM_SPACE: texture is rendered when the user is |
| | | | inside the rendering space at the texture coordinates. |
| | | | The shape and size of the rendering space is defined |
| | | | by the same parameters as used for projectionTexture. |
| | | | RM_ON: texture is always rendered at the specified |
| | | | texture coordinates. |
| accessor | number | N/A | Provides a reference to the accessor [symbol] by specifying the |
| | | | accessor's index in accessors array, that describes the |
| | | | buffer where the decoded timed texture will be made |
| | | | available. |

[symbol]

indicates data missing or illegible when filed

Table 3 defines the different attributes under the MPEG_360_video extension, which defines attributes describing the necessary parameters for each projected 360 video and its corresponding projection texture. The syntax of the attributes are shown under the “Name” column, and their corresponding semantics are shown under the “Description” column. The position of each 360 video and its projection texture is defined through already existing parameters in the scene description format (such as glTF). At each position defined, the MPEG_360_video extension may contain either, or both YUV and depth data. The renderMode attribute defines further the intended rendering of the 360 video at the corresponding position.

FIG. 6 illustrates the different rendering modes as defined by the renderMode attribute.

These three rendering modes are defined for each 360 video at the position specified, in accordance with the user's position during the playback/rendering of the scene.

RM_CENTER:
The 360 video (and its corresponding texture) is only rendered when the user's position in the scene corresponds to the inside exact center of the 360 video texture.

RM_SPACE:
The 360 video (and its corresponding texture) is rendered when the user's position in the scene lies within the space inside the 360 video texture, the space as defined by the additional parameters.

RM_ON:
The 360 video (and its corresponding texture) is always rendered in the scene, irrelevant of where the user's position is (either inside the 360 video texture, or outside it).

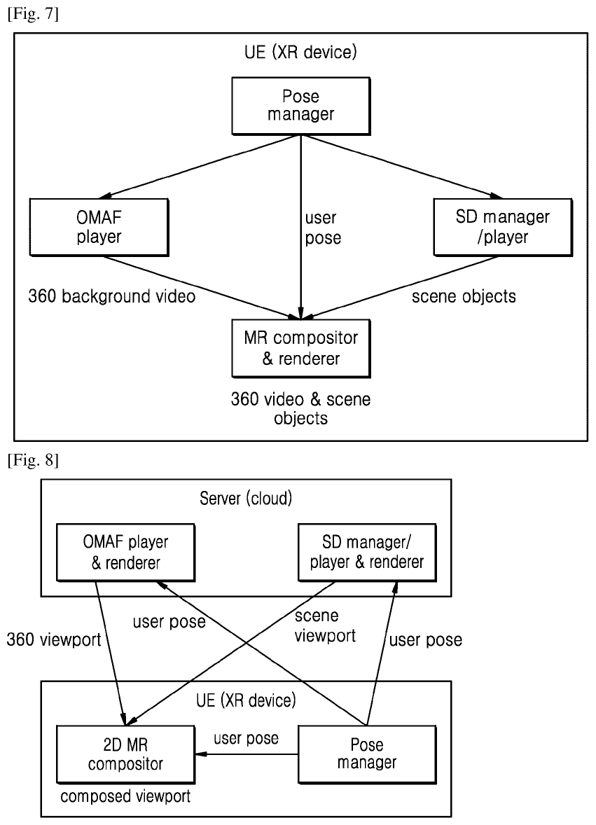

FIG. 7 illustrates an embodiment of present disclosure.

Embodiment 1:
A 360 video player (e.g. OMAF player) is used as a plugin to the scene description pipeline.
All components are run on the UE (XR device).
The necessary media and metadata has been obtained onto the UE, through means such as download or streaming from a media server, or from storage mediums etc.
The pose manager tracks and outputs the user's most update pose information (c.g. position x, y, z, and orientation).
The OMAF player takes one or more 360 videos as its media input, and renders one or more complete 360 (background) videos. In order to select the 360 video which should be rendered at the user's current position, pose information can also be used from the pose manager. The OMAF player sends the complete 360 video to the MR (media resource) compositor.
Independent to the OMAF player, the scene description (SD) manager/player takes one or more 3D objects as its media input, and decodes/places the objects in the scene. These placed objects (in 3D) are then sent to the MR compositor.
The MR compositor/renderer takes both the 360 video(s) and the scene objects as inputs, and using the pose information of the user from the pose manager, composes the 3D scene which incorporates both the 360 video and the scene objects. After composition, a 2D rendered frame is output from the compositor/renderer, based on the user's pose information.
In the embodiment 1, the OMAF player already contains the relevant information about the multiple 360 videos and their inter-space relationships. Since the rendering of 360 video is independent of that of the scene objects in the scene description, MPEG_360_space information in Table 2 which describe the relationship between the OMAF coordinates and the scene description coordinates is required for the correct composition of the two component's outputs by the MR compositor/renderer. MPEG_360_video information in Table 3 can be considered optional in the embodiment 1.

FIG. 8 illustrates an embodiment of present disclosure.

Embodiment 2:
A 360 video player (e.g. OMAF player) is used as a plugin to the scene description pipeline.
Certain components are run on a server (cloud) and some on the UE (XR device), as shown in FIG. 8.
The necessary media and metadata has been provisioned and ingested in the server.
The pose manager tracks and outputs the user's most update pose information (e.g. position x, y, z, and orientation).
The OMAF player takes one or more 360 videos as its media input, and renders one or more complete 360 (background) videos. In order to select the 360 video which should be rendered at the user's current position, pose information can also be used from the pose manager. Once the 360 video is selected and rendered, the exact viewport of the 360 video is further extracted using the user pose information. This 360 viewport is then sent by the server to the UE XR device through the network.
Independent to the OMAF player, the scene description (SD) manager/player takes one or more 3D objects as its media input, and decodes/places the objects in the scene. A view frustum based on the user pose information is then used to render a 2D scene viewport. This 2D scene viewport is then sent by the server to the UE XR device through the network.
The 2D MR compositor takes both the 360 viewport and the scene viewport as inputs, and using the pose information of the user from the pose manager, creates a composed 2D viewport.
In the embodiment 2, the OMAF player already contains the relevant information about the multiple 360 videos and their inter-space relationships. Since the rendering of 360 video is independent of that of the scene objects in the scene description, MPEG_360_space information in Table 2 which describe the relationship between the OMAF coordinates and the scene description coordinates is required for the correct composition of the two component's outputs by the MR compositor/renderer. MPEG_360_video information in Table 3 can be considered optional in this embodiment.
The rendering of the media in the server, and the delivery of rendered 2D viewports much reduce the bandwidth needed over the network, instead of sending the complete 360 video(s) and 3D scene objects.
The embodiment 2 also reduces the amount of computational complexity required in the UE since it does not need to decode or render 360 video, or 3D object media directly.

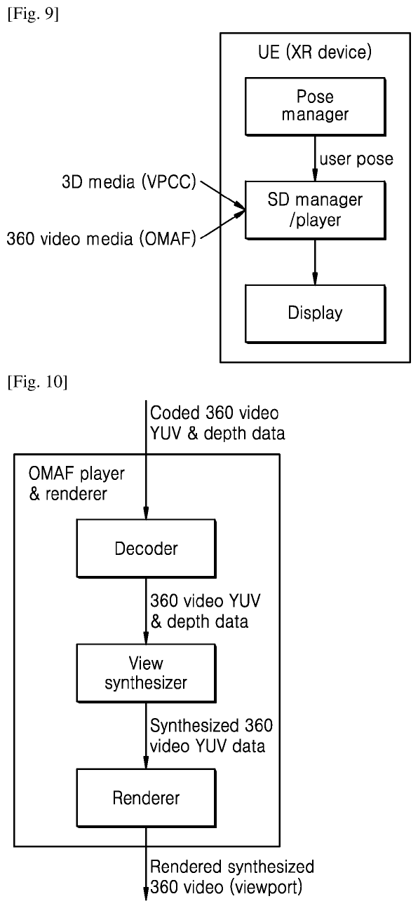

FIG. 9 illustrates an embodiment of present disclosure.

Embodiment 3:
360 video (OMAF videos) are considered as one of the media data inside the scene description pipeline (e.g. as textured objects with corresponding MPEG timed media in the scene description).
360 video (OMAF) tracks are referenced as MPEG external media sources
360 video (OMAF) tracks are mapped to specified coordinates in the scene as defined by the texture objects related to the MPEG_360_video extension attributes in Table 3.
360 video (OMAF) is projected onto textured objects as defined by the MPEG_360_video extension attributes in Table 3.
In the embodiment 3, all media data is fed into, managed, decoded, composed, and rendered by the scene description manager/player. Media data of relevance to this disclosure include 3D media (objects), such as MPEG V-PCC media, and 360 video media, such as MPEG OMAF media.
The scene manager composes the scene using the metadata from the MPEG_360_video and MPEG_360_space extensions in order to compose the scene which includes 360 videos.
Depending the available media data, and the user's location, the SD manager/player may also create synthesized 360 videos specific to the location of the user.
Depending on the user's pose location, and the rendering modes of the 360 videos inside the scene, the user is able to experience a rendered scene which includes both 360 video (possibly as a background), and also 3D objects.

FIG. 10 illustrates placement of a view synthesizer component.

FIG. 10 illustrates the integration of a view synthesizer component within the OMAF player & renderer, which can be integrated with both disclosures shown in FIGS. 7 and 8.

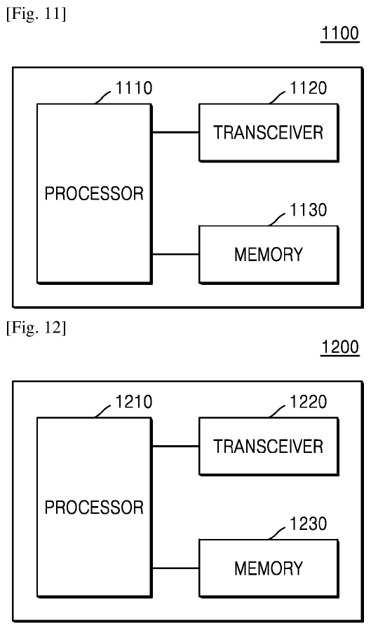

FIG. 11 illustrates a server according to embodiments of the present disclosure.

Referring to the FIG. 11, the server 1100 may include a processor 1110, a transceiver 1120 and a memory 1130. However, all of the illustrated components are not essential. The server 1100 may be implemented by more or less components than those illustrated in FIG. 11. In addition, the processor 1110 and the transceiver 1120 and the memory 1130 may be implemented as a single chip according to another embodiment.

The aforementioned components will now be described in detail.

The processor 1110 may include one or more processors or other processing devices that control the proposed function, process, and/or method. Operation of the server 1100 may be implemented by the processor 1110.

The transceiver 1120 may include a RF transmitter for up-converting and amplifying a transmitted signal, and a RF receiver for down-converting a frequency of a received signal. However, according to another embodiment, the transceiver 1120 may be implemented by more or less components than those illustrated in components.

The transceiver 1120 may be connected to the processor 1110 and transmit and/or receive a signal. The signal may include control information and data. In addition, the transceiver 1120 may receive the signal through a wireless channel and output the signal to the processor 1110. The transceiver 1120 may transmit a signal output from the processor 1110 through the wireless channel.

The memory 1130 may store the control information or the data included in a signal obtained by the server 1100. The memory 1130 may be connected to the processor 1110 and store at least one instruction or a protocol or a parameter for the proposed function, process, and/or method. The memory 1130 may include read-only memory (ROM) and/or random access memory (RAM) and/or hard disk and/or CD-ROM and/or DVD and/or other storage devices.

FIG. 12 illustrates a XR device according to embodiments of the present disclosure.

Referring to the FIG. 12, the XR device 1200 may include a processor 1210, a transceiver 1220 and a memory 1230. However, all of the illustrated components are not essential. The XR device 1200 may be implemented by more or less components than those illustrated in FIG. 12. In addition, the processor 1210 and the transceiver 1220 and the memory 1230 may be implemented as a single chip according to another embodiment.

The aforementioned components will now be described in detail.

The processor 1210 may include one or more processors or other processing devices that control the proposed function, process, and/or method. Operation of the XR device 1200 may be implemented by the processor 1210.

The transceiver 1220 may include a RF transmitter for up-converting and amplifying a transmitted signal, and a RF receiver for down-converting a frequency of a received signal. However, according to another embodiment, the transceiver 1220 may be implemented by more or less components than those illustrated in components.

The transceiver 1220 may be connected to the processor 1210 and transmit and/or receive a signal. The signal may include control information and data. In addition, the transceiver 1220 may receive the signal through a wireless channel and output the signal to the processor 1210. The transceiver 1220 may transmit a signal output from the processor 1210 through the wireless channel.

The memory 1230 may store the control information or the data included in a signal obtained by the XR device 1200. The memory 1230 may be connected to the processor 1210 and store at least one instruction or a protocol or a parameter for the proposed function, process, and/or method. The memory 1230 may include read-only memory (ROM) and/or random access memory (RAM) and/or hard disk and/or CD-ROM and/or DVD and/or other storage devices.

At least some of the example embodiments described herein may be constructed, partially or wholly, using dedicated special-purpose hardware. Terms such as ‘component’, ‘module’ or ‘unit’ used herein may include, but are not limited to, a hardware device, such as circuitry in the form of discrete or integrated components, a Field Programmable Gate Array (FPGA) or Application Specific Integrated Circuit (ASIC), which performs certain tasks or provides the associated functionality. In some embodiments, the described elements may be configured to reside on a tangible, persistent, addressable storage medium and may be configured to execute on one or more processors. These functional elements may in some embodiments include, by way of example, components, such as software components, object-oriented software components, class components and task components, processes, functions, attributes, procedures, subroutines, segments of program code, drivers, firmware, microcode, circuitry, data, databases, data structures, tables, arrays, and variables. Although the example embodiments have been described with reference to the components, modules and units discussed herein, such functional elements may be combined into fewer elements or separated into additional elements. Various combinations of optional features have been described herein, and it will be appreciated that described features may be combined in any suitable combination. In particular, the features of any one example embodiment may be combined with features of any other embodiment, as appropriate, except where such combinations are mutually exclusive. Throughout this specification, the term “comprising” or “comprises” means including the component(s) specified but not to the exclusion of the presence of others.

Attention is directed to all papers and documents which are filed concurrently with or previous to this specification in connection with this application and which are open to public inspection with this specification, and the contents of all such papers and documents are incorporated herein by reference.

All of the features disclosed in this specification (including any accompanying claims, abstract and drawings), and/or all of the steps of any method or process so disclosed, may be combined in any combination, except combinations where at least some of such features and/or steps are mutually exclusive.

Each feature disclosed in this specification (including any accompanying claims, abstract and drawings) may be replaced by alternative features serving the same, equivalent or similar purpose, unless expressly stated otherwise. Thus, unless expressly stated otherwise, each feature disclosed is one example only of a generic series of equivalent or similar features.

The invention is not restricted to the details of the foregoing embodiment(s). The invention extends to any novel one, or any novel combination, of the features disclosed in this specification (including any accompanying claims, abstract and drawings), or to any novel one, or any novel combination, of the steps of any method or process so disclosed.

1. (canceled)

2. A method performed by a user equipment, the method comprising:
identifying pose information of a user;
obtaining a 360 video or a 360 viewport of the 360 video, based on the pose information of the user;
obtaining a scene object in which at least one 3 dimensional (3D) object is placed or a scene viewport of the scene object; and
composing a 3D scene by incorporating, based on the pose information of the user and metadata, the 360 video with the scene object or the 360 viewport with the scene viewport,
wherein the metadata includes information indicating relation between coordinates of the 360 video and the scene object.

3. The method of claim 2, wherein obtaining the 360 video comprises selecting the 360 video among a plurality of 360 videos based on a user position indicated by the pose information of the user.

4. The method of claim 2, further comprising transmitting, to a server, the pose information of the user,
wherein obtaining the 360 viewport of the 360 video comprises, in case that the 360 viewport of the 360 video is extracted based on the pose information of the user at the server, receiving the 360 viewport of the 360 video from the server.

5. The method of claim 2, further comprising transmitting, to a server, the pose information of the user,
wherein obtaining the scene viewport of the scene object comprises, in case that the scene viewport of the scene object is rendered based on the pose information of the user at the server, receiving the scene viewport of the scene object from the server.

6. The method of claim 2, wherein the information indicating the relation between the coordinates of the 360 video and the scene object includes coordinates of a reference point in the scene object which corresponds to an origin defined in the 360 video.

7. The method of claim 2, wherein the 360 video and the scene object are included in a scene description.

8. The method of claim 7, wherein the metadata further includes at least one of YUV data or depth data.

9. A method performed by a server, the method comprising:
receiving pose information of a user from a user equipment;
obtaining a 360 viewport of a 360 video and a scene viewport of a scene object in which at least one 3 dimensional (3D) object is placed, based on the pose information of the user; and
transmitting the 360 viewport and the scene viewport to the user equipment,
wherein the 360 viewport is incorporated with the scene viewport at the user equipment for composing a 3D scene, based on the pose information of the user and metadata, and
wherein the metadata includes information indicating relation between coordinates of the 360 video and the scene object.

10. The method of claim 9, wherein obtaining the 360 viewport of the 360 video comprises:
based on the pose information of the user, selecting the 360 video among a plurality of 360 videos; and
extracting the 360 viewport from the 360 video.

11. The method of claim 9, wherein obtaining the scene viewport of the scene object comprises rendering the scene viewport of the scene object based on the pose information of the user.

12. A user equipment comprising:
a transceiver; and
at least one processor coupled with the transceiver and configured to:
identify pose information of a user,
obtain a 360 video or a 360 viewport of the 360 video, based on the pose information of the user,
obtain a scene object in which at least one 3 dimensional (3D) object is placed or a scene viewport of the scene object, and
compose a 3D scene by incorporating, based on the pose information of the user and metadata, the 360 video with the scene object or the 360 viewport with the scene viewport,
wherein the metadata includes information indicating relation between coordinates of the 360 video and the scene object.

13. The user equipment of claim 12, wherein the at least one processor is further configured to select the 360 video among a plurality of 360 videos based on a user position indicated by the pose information of the user.

14. The user equipment of claim 12, wherein the at least one processor is further configured to:
transmit, to a server, the pose information of the user, and
in case that the 360 viewport of the 360 video is extracted based on the pose information of the user at the server, receive the 360 viewport of the 360 video from the server.

15. The user equipment of claim 12, wherein the at least one processor is further configured to:
transmit, to a server, the pose information of the user, and
in case that the scene viewport of the scene object is rendered based on the pose information of the user at the server, receive the scene viewport of the scene object from the server.

16. The user equipment of claim 12, wherein the information indicating the relation between the coordinates of the 360 video and the scene object includes coordinates of a reference point in the scene object which corresponds to an origin defined in the 360 video.

17. The user equipment of claim 12, wherein the 360 video and the scene object are included in a scene description.

18. The user equipment of claim 17, wherein the metadata further includes at least one of YUV data or depth data.

19. A server comprising:
a transceiver; and
at least one processor coupled with the transceiver and configured to:
receive pose information of a user from a user equipment,
obtain a 360 viewport of a 360 video and a scene viewport of a scene object in which at least one 3 dimensional (3D) object is placed, based on the pose information of the user, and
transmit the 360 viewport and the scene viewport to the user equipment,
wherein the 360 viewport is incorporated with the scene viewport at the user equipment for composing a 3D scene, based on the pose information of the user and metadata, and
wherein the metadata includes information indicating relation between coordinates of the 360 video and the scene object.

20. The server of claim 19, wherein the at least one processor is further configured to:
based on the pose information of the user, select the 360 video among a plurality of 360 videos, and
extract the 360 viewport from the 360 video.

21. The server of claim 19, wherein the at least one processor is further configured to render the scene viewport of the scene object based on the pose information of the user.
